(19) United States
(12) Patent Application Publication
(10) Pub. No.: US 2015/0240340 A1
(43) Pub. Date: Aug. 27, 2015

(54) MACHINABLE COPPER ALLOYS FOR ELECTRICAL CONNECTORS

(71) Applicant: Baoshida Swissmetal AG, Reconvillier (CH)

(72) Inventors: Vincent Runser, Froeningen (FR); Giulio Caccioppoli, Diesse (CH); Jean-Pierre Tardent, Les Genevez (CH)

(21) Appl. No.: 14/422,959

(22) PCT Filed: Aug. 21, 2013
(86) PCT No.: PCT/EP2013/067365

§ 371 Date: Feb. 20, 2015

(30) Foreign Application Priority Data
Aug. 22, 2012 (CH) 1438/12

(51) Int. Cl. C22F 1/08; C22C 9/06; H01R 4/18; C22F 1/00

(52) U.S. Cl. CPC C22F 1/08; C22F 1/002; C22C 9/06; H01R 4/18

(57) ABSTRACT

The present disclosure concerns a machinable precipitation hardenable copper alloy comprising between 1 and 4.1 wt. % of Ni; between 0.3 and 3.0 wt. % of Si; between 0.4 and 4.0 wt. % of Pb; no more than 0.5 wt. % of Sn; no more than 0.5 wt. % of Cr; no more than 0.5 wt. % of Zn; no more than 0.5 wt. % of Zr; no more than 0.1 wt. % of Fe; no more than 0.3 wt. % of P; and unavoidable impurities; the remainder being constituted essentially of Cu. The present disclosure further concerns a production method for obtaining a semi-finished copper alloy product comprising the copper alloy. Said copper alloy product can be used for manufacturing electrical connectors such as sockets and pins.

### FIELD

The present disclosure relates to machinable precipitation hardening copper alloys of type Cu—Ni—Si, particularly suited for applications in areas such as electrical connectors, spring hard contacts having a high mechanical withstand and a high cold formability, used particularly for electric screw machined parts. The disclosure further relates to a production method of a semi-finished copper-based product comprising said copper alloy.

### DESCRIPTION OF RELATED ART

Today specific needs are increasing in the field of connector alloys, which is considered to be the innovative driving force to provide the right technical solutions to the end users according their new expectations with the commercialization of innovative copper basis alloys. The overall tendencies are:
improving the performances of finished parts in terms of resistance, reliability and durability;
downsizing of parts and reducing the weight of the contact;
high strength in combination with an improved deformability and a good conductivity; and
setting the processing parameters of the raw semi-finished products to increase the productivity and control the production costs: machinability, move to the crimping contacts instead of soldered contact, eliminate the costly operation such as the zone annealing before crimping the contact.

The precipitation hardenable alloy of Cu—Ni—Si found quickly an industrial application for various fields requiring a medium to high strength, a good remaining electrical conductivity and a good behavior against the fatigue for parts under a thermal or a mechanical load. Cu—Ni—Si alloys are mainly strengthened by high-temperature quenching and subsequent heat-treatment, which induces the precipitation of a second phase (δ-Ni2Si) in the copper matrix and hence improves the strength.

Usually, such alloys go through the following processing: casting (continuous or semi-continuous), hot and cold deformation, solution treated and quenched in water, cold worked and finally aged under inert atmosphere at about 400-600° C. during various periods depending on the characteristics to achieve.

Such alloys are known for their outstanding properties because the combination of strength and conductivity they cover, which are superior of other precipitation hardenable copper-based alloys like for example Cu—Fe—P, Cu—Ni—P, Cu—Cr—Zr. The precipitations responsible for the strengthening effect have been identified as Ni2Si precipitates. However they are exclusively restricted for non-machining parts because of their non machinable nature.

The adjunction of Pb in the nominal chemical composition of copper alloys improves significantly the machining property, suitable for the manufacture of precision screw machining parts such as connector pins and sockets. The lead is present as dispersed fine and homogeneous particles in the copper matrix. The lead particles play the role as lubricant and at the same time as chip breaker and therefore facilitate the forming and the removing of thin chips on the surface and guarantee a clean machined surface quality. Free cutting copper like Cu—Ni—P—Pb and Cu—Pb—P are largely reputed for their machining performance.

A certain number of alloys like machinable leaded spinodal alloys in copper-nickel-tin family, such as the alloy described in U.S. Pat. No. 0,089,816 by the present applicant, can compete against machinable beryllium copper alloys in terms of resistance and machinability. The weakness of such alloys, particularly for segment of electric and electronic parts is the low electrical conductivity. Some Cu—Ni—Si alloys offer interesting properties in that respect, because of the higher quantity of the conductive copper in the composition and the possibility of precipitation in the structure. None of these Cu—Ni—Si alloys are delivered till today in a machinable form on automatic lathers, which restricts their use in the world of the connectors industry.

The delivered semi-finished product must be designed for end users in order to perform a crimped terminal connection, which is preferred to the soldered terminal connections. That does mean that the most of machined parts requires after a number of turning and/or drilling operations to be locally heated up to a solution heated temperature to soften enough the tube before to crimp it. The elongation is considerably increased and the hardness reduced the lower yield strength is sufficient low to accommodate the plastic deformation and ensure the best electrical contact. Nevertheless, such operation is always delicate, almost for thin parts, because it requires the thermal treatment of a very small area of the part without influencing the rest.

The complete solubility of Ni in Cu increase due to the solid solution strengthening the strength at different level but the elastic modulus and the corrosion withstand as well.

The manufacturing process comprises in a further step of aging treatment to achieve a peak-aged state and which leads to the high performance properties of the Cu—Ni—Si alloy: high mechanical strength and good electrical conductivity corresponding to peak aging. This condition promotes a fine distribution of precipitates from different natures, principally composed of needle shape Ni₂Si precipitates, responsive for the high stress, the spring properties and good formability. A good compromise in the definition of aging conditions between the softening due to the recrystallization and the strengthening during the aging has to be found to offer the best parts design. Silicon increases strength, wear resistance and corrosion resistance.

In precipitation hardenable copper alloys, increasing strength is usually at the expense of ductility and conductibility. Through a precise investigation of the expected variation in mechanical strength and electrical conductivity during manufacturing process of the semi-finished products, including casting, solution heat treatment and aging heat treatment, the machined Cu—Ni—Si family appears as a multi-functional material able to cover various applications, mainly in the field of connectors manufacturing.

### SUMMARY

The aim of the present invention is to provide a new generation of machinable alloys based on the system Cu—Ni—Si—Pb. Thanks to a special thermo-mechanical treatment and an optimized alloy composition they reach mechanical properties while remaining high cold deformability and offering excellent machining performance, which is the key factor for the end users in terms of productivity.

The invention concerns the technological development and industrialization of a range of innovative semi-finished products on the basis of Cu—Ni—Si—Pb, which are destined to the manufacturing of machined and/or cold headed precision parts such as electrical contacts. The range of products targets mainly the production of rods and wires having a diameter comprised between 0.2 mm and 200 mm, but might concerns also profiles from 0.05 kg/m up to 100 kg/m including square and hexagonal cross sections. The product is obtained by continuous or semi-continuous casting of billets and wire. A spray casting technique can also be used for manufacture of billets of this alloy family.

In that respect, this present disclosure relates to the technological development and industrialization of a range of innovative semi-finished copper-basis products destined to the manufacturing of machined and/or cold headed parts used mainly for electric and electronic connectors. Due to a well-adjusted and mastered chemical composition and using the best combination of manufacturing process, the innovative precipitation hardenable copper alloy family shows a very interesting potential for the industry of tomorrow, because of its ability to be machined. This new generation of machinable alloys based on the Cu—Ni—Si—Pb system would have to go through a specific manufacturing process to reach finally the interesting properties such as good cold deformability, high strength in combination with a good thermal and electrical conductivity. The range of semi-finished products, which is destined to be industrialized, concerns the production of wires and rod having a diameter comprised between 0.2 mm and 200 mm, and profiles from 0.05 kg/m up to 100 kg/m including square and hexagonal cross sections.

The present disclosure relates to machinable and/or cold headable Cu—Ni—Si—Pb alloys suitable for machined precision parts manufacturing in the field of electric contacts, requiring a high strength and a high electrical and thermal conductivity as well as a good cold formability. This alloy type is strengthened by a precipitation hardening treatment. In an embodiment, a machinable precipitation hardenable copper alloy can comprise:

Ni: 1-4.1 wt. %

Si: 0.3-3.0 wt. %

Pb: 0.4-4.0 wt. %

Zn: ≦0.5 wt. %

Sn: ≦0.5 wt. %

Cr: ≦0.5 wt. %

Zr: ≦0.5 wt. %

Fe: ≦0.05 wt. %

P: ≦0.3 wt. %

unavoidable impurities

Cu: remainder.

wherein unavoidable impurities can be no more than 0.3 wt. %. In a variant, the copper alloy comprises no more than 0.1 wt. % of Fe. In a further variant, the Pb content is comprised between 0.5 and 3 wt. %.

Furthermore, due to the possibility to precipitate different second particles in the copper matrix, the machinable copper alloy exhibits a wide range of achievable processing properties suitable for machining, stamping, bending, crimping because of the good remaining cold formability. A controlled adjustment of the composition allows the possibility of offering an excellent compromise with superior mechanical properties combined with a high conductivity and with a good machinability on automatic lathers.

In an embodiment, a semi-finished copper alloy product can be obtained by combining the machinable copper alloy with a suitable production method comprising:

performing one of continuous wire casting, billet casting, and billet spray compacting on said alloy;

hot forming;

solution heat treating at a temperature comprised between 800 and 950° C. for a time period comprised between 10 and 30 min;

quenching from the solution treating temperature;

cold deformation; and

aging at a temperature comprised between 380 and 600° C. and a time period comprised between 1 h to 5 h.

The copper alloy product obtained by the method above can show a high cold formability, about minimum of 8% elongation, in combination with a high strength at minimum 650 MPa or 550 MPa. The copper alloy product can also show a very high strength over 1000 MPa. The copper alloy product can further have an electrical conductivity of at least 30% IACS (for the highest strength). Such electrical conductivity corresponds fully to the expectations of electric parts manufacturers. The copper alloy product is particularly suited for applications in areas such as electrical connectors, spring hard contacts having a high mechanical withstand and a high cold formability, used particularly for electric screw machined parts. The high machining performances and the high strength with sufficient ductility combined with a high stress relaxation resistance confer to the copper alloy product an innovative potential.

In a first variant the machinable copper alloy can comprise about 2.5 wt. % of Ni, about 0.4 wt. % of Si, about 1.0 wt. % of Pb, and the remainder being constituted essentially of Cu. The copper alloy product obtained from combining the copper alloy according to the first variant with the production method shows an important level of remaining ductility combined with a high resistance and a good electrical conductivity, and thus allows the possibility of operating a crimp connection without needing a zone annealing.

The market underwent an evolution by introducing machinable products regarding new environmental and wealthy legislations regarding toxic compounds, where good conductivity is required in combination with high strength. In a second variant, the machinable copper alloy can comprise between about 3.5-4.0 wt. % of Ni, between about 0.7-1.0 wt. % of Si, between about 0.8-1.2 wt. % of Pb, and the remainder being constituted essentially of Cu. The copper alloy product obtained from combining the copper alloy according to the second variant with the production method has a high strength and high electrical conductivity, and appears as a technical solution for high strength copper alloys, showing interesting properties.

In an embodiment, the copper alloy according to the second variant (originally: comprise For Ni superior to 3 wt. % combined with Si superior to 0.8 wt. %) can be combined with the production method such that the strength of the copper alloy product can reach 1000 MPa with an electrical conductivity of minimum 30% IACS.

### DETAILED DESCRIPTION OF POSSIBLE EMBODIMENTS

According to an embodiment, a machinable precipitation hardenable copper alloy comprises:

between 1 and 4.1 wt. % of Ni;

between 0.3 and 3.0 wt. % of Si;

between 0.4 and 4.0 wt. % of Pb;

no more than 0.5 wt. % of Sn;

no more than 0.5 wt. % of Cr;

no more than 0.5 wt. % of Zn;

no more than 0.5 wt. % of Zr;

no more than 0.1 wt. % of Fe;

no more than 0.3 wt. % of P; and

Other impurities ≦0.3 wt. %;

the remainder being Cu.

The copper alloy comprises a well-controlled amount of lead in the composition, which appears as insoluble lead particles dispersed in the copper matrix of the Cu—Ni—Si alloy. The addition of lead has a positive effect on the machining performance of the semi-finished parts. The result is the building of small chips easily removable, a reduced tool wear and a lower cutting effort.

The added Pb quantity depends on the final processing by the end users. Machining operations require an average amount of 1% or more Pb. For the cold heading operation alone, a lower quantity preferable in the range of 0.4-1% Pb is sufficient to expect the required lubricant effect during the high level of cold deformation.

In an embodiment, a method for producing a semi-finished copper alloy product comprising the disclosed copper alloy, comprises:

performing one of continuous wire casting, billet casting, and billet spray compacting on said alloy;

hot forming;

solution heat treating at a temperature comprised between 800 and 950° C. for 10 to 30 min;

quenching from the solution treating temperature;

performing a first step of cold deformation; and

performing a first aging step at a temperature comprised between 380 and 600° C. and a time period comprised between 1 to 5 h to achieve the mechanical and physical properties.

The copper alloy product has a ductility comprised between 1 and 20% depending on the first aging duration and the step of cold deformation before first aging step. The elongation and particularly the uniform cold deformability before necking appears might be reachable by further optimization of thermo-mechanical treatment. Said optimization of thermo-mechanical treatment can comprise performing said first cold deformation step with a high level of deformation, superior to 50% in the solutioned state, after performing the solution heat treatment step and the step of quenching, in water. Said optimization of thermo-mechanical treatment can further comprise a second aging step at temperature equal to about 500° C. or lower, such as to avoid coarse precipitation. The second step of aging at a temperature can be comprised between 380 to 500° C. The copper alloy product produced with the optimization of thermo-mechanical treatment has a uniform plastic deformation showing values over 6% in a tensile test.

The copper alloy product has machinability performance superior to classical well-known Cu—Ni—Si allowing for a higher production rate of precision parts, a good behavior against tool wear.

### EXAMPLE 1

In an embodiment, the alloy product can comprise the copper alloy having a first composition comprising:

Ni: about 2.5 wt. %;

Si: about 0.4 wt. %;

Pb: about 1.0 wt. %;

Impurities; and and

Cu: remainder;

In a variant, the copper alloy comprises no more than 1 wt. % impurities. In another variant, the copper alloy comprises about 2.5 wt. % of Ni; about 0.4 wt. % of Si;

about 1.0 wt. % of Pb; about 0.2 wt. % of Sn; about 0.1 wt. % of Cr; and 1 wt. % or less of at least one of Zn, Zr, Fe and P, and unavoidable impurities; the remainder being constituted essentially of Cu; wherein the unavoidable impurities can comprise no more than 1 wt. % impurities.

The product obtained from combining the copper alloy according to the first variant with the production method has high strength, i.e., superior to about 650 N/mm², an elevated yield strength of about 500 N/mm², an elongation at break A50 superior to about 8% and electrical conductivity superior to about 35% IACS.

Cold deformability of the copper alloy product having the first composition can be optimized in order to promote crimping ability of the contacts which are manufactured from the copper alloy product either by machining, cold heading, bending or any additional forming operations requiring a large cold deformability. Here, it is possible to crimp the electrical contact made from the copper alloy product without the need of an additional zone annealing operation. Moreover, the first composition comprising 1 wt % of lead facilitates the machinability and improves the productivity of the copper alloy product.

### EXAMPLE 2

In another embodiment, the copper alloy comprises:

Ni 3.5-4.0 wt. %;

Si 0.7-1.0 wt. %;

Pb 0.8-1.2 wt. %;

Sum of impurities ≦1.0 wt. %; and

Cu remainder.

The product obtained from combining the copper alloy according to the second variant with the production method offers a machinable version of a high strength copper based alloy, which shows good machinability for the manufacturing of precision parts with tightly tolerances, suitable for machining operations such as turning, drilling, milling etc.

In an embodiment, the copper alloy product comprising the second composition can be obtained using the production method further comprising a second step of cold deformation and a second step of aging, performed after the second cold deformation step. The second aging step can be performed at a temperature comprised between bout 360° C. and 480° C., for a time period of 1 to 5 h. The second cold deformation step can comprise various cold deformation level up to 20% maximum after the first aging treatment. The resulting copper alloy product has a mechanical strength comprised between 850 and 1050 MPa, an elongation limited to about 1-5%, and an electrical conductivity comprised between about 30 and 40% IACS. These values depend strongly on the temperature and duration of the further solution heat treating step.

In another embodiment, an optimal compromise between strength and electrical conductivity can be achieved by performing the second aging step for a short time period of 1 to 2 h, wherein the second cold deformation step is performed with a plastic deformation of at least 15%. The second aging step can be performed at a temperature above to 380° C. The two aging steps increase the dislocation density in the copper alloy and provide a saturated fine precipitated structure of needle NiSi-precipitates. For example, a tensile strength of about 1020 MPa and a conductivity of about 36% IACS can be achieved when the alloy product comprising the second composition is subjected to the two cold deformation steps and the two aging steps.

1. Machinable precipitation hardenable copper alloy comprising between 1 and 4.1 wt. % of Ni; between 0.3 and 3.0 wt. % of Si; between 0.4 and 4.0 wt. % of Pb; no more than 0.5 wt. % of Sn; no more than 0.5 wt. % of Cr; no more than 0.5 wt. % of Zn; no more than 0.5 wt. % of Zr; no more than 0.1 wt. % of Fe; no more than 0.3 wt. % of P; and unavoidable impurities; the remainder being constituted essentially of Cu.

2. The copper alloy according to claim 1, wherein
wherein said unavoidable impurities comprises no more than 0.3 wt. %.

3. The copper alloy according to claim 1,
comprising no more than 0.05 wt. % of Fe.

4. The copper alloy according to claim 1, wherein the Pb content is comprised between 0.5 and 3 wt. %.

5. The copper alloy according to claim 1, wherein the Pb content is comprised between 0.5 and 1 wt. %.

6. Production method for obtaining a semi-finished copper alloy product comprising the alloy characterized by claim 1, the method comprising:
performing one of continuous wire casting, billet casting, and billet spray compacting on said alloy;
hot forming;
solution heat treatment at a temperature comprised between 800 and 950° C., for a time period comprised between 10 to 30 min;
quenching from the solution heat treating temperature;
performing a first cold deformation step; and
performing a first aging step at a temperature comprised between 380 and 600° C. and a time period comprised between 1 h to 5 h.

7. The method according to claim 6,
further comprising a second step of aging at a temperature comprised between 380 to 500° C.

8. The method according to claim 6,
wherein said copper alloy comprises about 2.5 wt. % of Ni; about 0.4 wt. % of Si; about 1.0 wt. % of Pb; and unavoidable impurities.

9. The method according to claim 8,
further comprising about 0.2 wt. % of Sn; about 0.1 wt. % of Cr; and 1 wt. % or less of at least one of Zn, Zr, Fe and P; the remainder being constituted essentially of Cu.

10. The method according to claim 8,
wherein said copper alloy comprises no more than 1 wt. % impurities.

11. The method according to claim 6,
wherein said copper alloy comprises between 3.5 and 4.0 wt. % of Ni; between 0.7 and 1.0 wt. % of Si; between 0.8 and 1.2 wt. % of Pb; and no more than 1 wt. % impurities.

12. The method according to claim 11,
further comprising a second step of cold deformation, and a second aging step at a temperature between 360° C. and 480° C. for a time period comprised between 1 to 5 h, such as to achieve a mechanical strength comprised between 850 and 1050 MPa and a remaining electrical conductivity comprised between about 30 and 40% IACS of the copper alloy product.

13. The method according to claim 12, wherein
said second aging step is performed at a temperature above to 380° C.

14. Semi-finished copper-based product produced by the method according to claim 6.

15. The product according to claim 14,
having good ductility, and that can be crimped without needing an additional zone annealing.

16. The product according to claim 15,
used for manufacturing electrical connectors.

17. The product according to claim 16, wherein
said electrical connectors comprise sockets or pins.
